(19) United States
(12) Patent Application Publication
(10) Pub. No.: US 2022/0035733 A1
(43) Pub. Date: Feb. 3, 2022

(54) METHOD AND APPARATUS FOR CHECKING AUTOMATIC DRIVING ALGORITHM, RELATED DEVICE AND STORAGE MEDIUM

(71) Applicant: APOLLO INTELLIGENT CONNECTIVITY (BEIJING) TECHNOLOGY CO., LTD., Beijing (CN)

(72) Inventors: Houqiang Zhu, Beijing (CN); Pengfei Wei, Beijing (CN); Jia Song, Beijing (CN)

(73) Assignee: APOLLO INTELLIGENT CONNECTIVITY (BEIJING) TECHNOLOGY CO., LTD., Beijing (CN)

(21) Appl. No.: 17/501,401

(22) Filed: Oct. 14, 2021

(30) Foreign Application Priority Data
Dec. 25, 2020 (CN) 202011562221.X

(51) Int. Cl. G06F 11/36; B60W 60/00; G06K 9/62

(52) U.S. Cl. CPC G06F 11/3688; B60W 60/0027; G06K 9/6257; B60W 2756/10; B60W 2555/20; B60W 2400/00; G06F 11/3696

(57) ABSTRACT

The disclosure provides a method and an apparatus for checking an automatic driving algorithm, a related device and a storage medium. The travelling data during a travelling process of the vehicle is obtained. The travelling data includes the environmental parameter and/or the state parameter of the vehicle. The travelling data is processed using an automatic driving algorithm to be checked to generate the prediction result. The reference result corresponding to the travelling data is obtained. The reliability of the automatic driving algorithm to be checked is determined based on the difference between the prediction result and the reference result.

### CROSS REFERENCE TO RELATED APPLICATION(S)

This application claims priority and benefits to Chinese Application No. 202011562221.X, filed on Dec. 25, 2020, the entire content of which is incorporated herein by reference.

### TECHNICAL FIELD

The disclosure relates to a field of computer technologies, a field of artificial intelligence technologies, a field of automatic driving technologies, a field of intelligent transportation technologies, and a field of computer vision technologies, and more particularly to a method and an apparatus for checking an automatic driving algorithm, a related device and a storage medium.

### BACKGROUND

With mass production of smart vehicles in host machine manufacturers, autonomous driving algorithm models provided by various technology suppliers are rapidly iterated, with continuously optimized scene problems and expanded autonomous travelling capabilities of the vehicle. During the technology iteration, a large number of vehicle-in-the-loop tests are required to perform on each version of the automatic driving algorithm.

### SUMMARY

In one embodiment, there is provided a method for checking an automatic driving algorithm. The method includes: obtaining travelling data during a travelling process of a vehicle, the travelling data including an environmental parameter and/or a state parameter of the vehicle; processing the travelling data using an automatic driving algorithm to be checked to generate a prediction result; obtaining a reference result corresponding to the travelling data; and determining a reliability of the automatic driving algorithm to be checked based on a difference between the prediction result and the reference result.

In one embodiment, there is provided an electronic device. The electronic device includes: at least a processor; and a memory communicatively coupled to at least one processor. The memory stores instructions executable by the at least one processor. When the instructions are executed by the at least one processor, the at least one processor is configured to execute a method for checking an automatic driving algorithm as described above.

In one embodiment, there is provided a non-transitory computer-readable storage medium, having computer programs stored thereon. The computer instructions are configured to cause a computer to execute a method for checking an automatic driving algorithm as described above.

It is to be understood that the content in this part is not intended to identify key or important features of the embodiments of the disclosure, and does not limit the scope of the disclosure. Other features of the present disclosure will be easily understood through the following specification.

### BRIEF DESCRIPTION OF THE DRAWINGS

The drawings are used to make the skilled person in the art to well understand the solution, and are not restrictive of the disclosure.

FIG. 1 is a flowchart illustrating a method for checking an automatic driving algorithm according to some embodiments.

FIG. 2 is another flowchart illustrating a method for checking an automatic driving algorithm according to some embodiments.

FIG. 3 is a schematic diagram illustrating an apparatus for checking an automatic driving algorithm according to some embodiments.

FIG. 4 is a block diagram illustrating an electronic device for implementing a method for checking an automatic driving algorithm according to some embodiments.

### DETAILED DESCRIPTION

The following describes exemplary embodiments of the disclosure with reference to the attached drawings, which include various details of the embodiments of the disclosure to facilitate understanding, and they should be considered as merely exemplary. Therefore, those skilled in the art should realize that various changes and modifications can be made to the embodiments described herein without departing from the scope and spirit of the disclosure. Similarly, for clarity and conciseness, descriptions of well-known functions and structures are omitted in the following description.

In order to facilitate the understanding of the disclosure, firstly, the following briefly explains the technical fields involved in the disclosure.

Artificial Intelligence is a subject that studies how to simulate certain human thinking processes and intelligent behaviors (such as learning, reasoning, thinking, planning, and the like) by the computer, including both hardware-level technologies and software-level technologies.

Artificial intelligence hardware technology generally includes technologies such as sensors, dedicated artificial intelligence chips, cloud computing, distributed storage, and big data processing. Artificial intelligence software technology generally includes computer vision technology, speech recognition technology, natural language processing technology and machine learning, deep learning, big data processing technology, and knowledge graph technology.

Autonomous driving refers to a driving assistance system that can assist a driver to steer the vehicle or keep driving the vehicle on the road and achieve a series of operations, such as vehicle-following, braking, and lane-changing. The driver can control the vehicle at any time, and the system can intervene by reminding the driver under some certain environments.

Intelligent transportation is a real-time, accurate, effective and comprehensive transportation management system, working in a wide range and all-round way, that is established by effectively integrating advanced information technologies, data communication transmission technologies, electronic sensing technologies, control technologies and computer technologies to the entire ground traffic management system, which is composed of two parts, i.e., traffic information service system and traffic management system.

Computer vision is a scientific field across subjects that studies how to obtain a high-level understanding from digital images or videos by the computer. From the perspective of engineering, it aims to find automatic tasks that can be done by the human visual system. Computer vision tasks include methods for obtaining, processing, analyzing, and understanding digital images, as well as methods for extracting high-dimensional data from the real world so as to generate digital or symbolic information in the form of decisions.

The method and the apparatus for checking an automatic driving algorithm, the related device and the storage medium will be described in combination with drawings below.

In the disclosure, the automatic driving algorithm to be checked is applied to a real vehicle that is travelling, and the real travelling data is used to check the automatic driving algorithm during the real travelling process of the vehicle, thereby not only ensuring the reliability of the check result, but also reducing the check cost.

It is understandable that in order to ensure the safety of the vehicle, the automatic driving algorithm to be checked may not be used in the real travelling control of the vehicle.

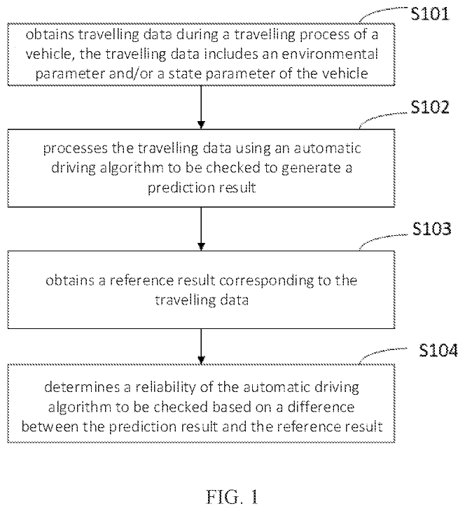

FIG. 1 is a flowchart illustrating a method for checking an automatic driving algorithm according to some embodiments of the disclosure.

The method for checking an automatic driving algorithm according to embodiments of the disclosure can be executed by an apparatus for checking an automatic driving algorithm according to embodiments of the disclosure. The apparatus can be integrated into any vehicle.

As illustrated in FIG. 1, the method for checking an automatic driving algorithm includes the following.

In block S101, travelling data is obtained during a travelling process of a vehicle. The travelling data includes an environmental parameter and/or a state parameter of the vehicle.

The environmental parameter may include all kinds of information related to the travelling of the vehicle, such as positions of pedestrians, positions of buildings, identifications of buildings, traffic indication information, position of nearby vehicles, a distance from a front vehicle in the surrounding environment when the vehicle is travelling. The state parameter of the vehicle may include vehicle speed, geographic location, and state of charge of the vehicle.

In detail, the vehicle can be arranged with various sensors for detecting the environment parameters and state parameters of the vehicle, such as a lidar, a camera, an acceleration sensor or the like. The vehicle can obtain the travelling data with various sensors while the vehicle is travelling.

In block S102, the travelling data is processed using an automatic driving algorithm to be checked to generate a prediction result.

The automatic driving algorithm to be checked may be any one of automatic driving algorithms used for the vehicle. The automatic driving algorithm to be checked can also be a certain automatic driving algorithm that is determined based on current travelling data.

For example, the automatic driving algorithms of the vehicle include an algorithm used to control the vehicle while the vehicle is travelling on a highway, an algorithm used to control the vehicle while the vehicle is travelling in a parking lot, and an algorithm used to control the vehicle while the vehicle is travelling on a main road of a city. Since the travelling data (e.g., a distance between vehicles, a vehicle speed, and location information) is different in different scenes, in embodiments of the disclosure, after obtaining the current travelling data of the vehicle, the automatic driving algorithm to be checked can be determined based on the obtained travelling data. Further, the travelling data is processed using an automatic driving algorithm to be checked to generate the prediction result.

The prediction result may be a result related to a travelling state of the vehicle, related to pedestrians outside the vehicle, or related to other vehicles. For example, the prediction result can be a safe speed at which the vehicle can safely pass a front traffic indicator, a period in which a pedestrian in front of the vehicle passes a front intersection, or a probability that a front vehicle suddenly brakes, which is not limited herein.

In block S103, a reference result corresponding to the travelling data is obtained.

The reference result is a reliable result used to check the prediction result generated by the automatic driving algorithm to be checked. The reference result may be determined based on a preset rule, based on an operation of a driver of a current vehicle, or based on real travelling data, which is not limited herein.

In block S104, a reliability of the automatic driving algorithm to be checked is determined based on a difference between the prediction result and the reference result.

In detail, when the difference between the reference result and the prediction result is large, it can be determined that the reliability of the automatic driving algorithm to be checked is low. When the difference between the reference result and the prediction result is small, it can be determined that the automatic driving algorithm to be checked have a certain degree of reliability.

In some embodiments of the disclosure, the travelling data is obtained during the travelling process of a vehicle. The travelling data is processed using the automatic driving algorithm to be checked to generate the prediction result. The reliability of the automatic driving algorithm to be checked is determined based on the difference between the prediction result and the corresponding reference result. Therefore, the reliability check in performed on the automatic driving algorithm based on the real travelling data obtained during the real travelling process of the vehicle, which not only reduces the check cost, but also ensures that the check result is true and reliable.

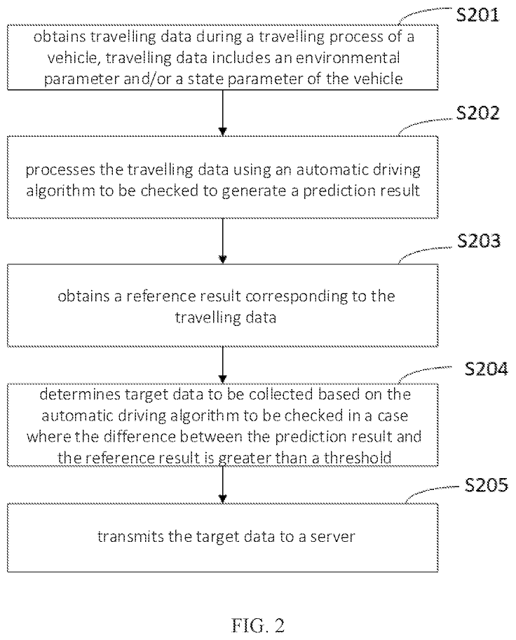

FIG. 2 is a flowchart illustrating a method for checking an automatic driving algorithm according to some embodiments of the disclosure. The method includes the following.

In block S201, travelling data is obtained during a travelling process of a vehicle. The travelling data includes an environmental parameter and/or a state parameter of the vehicle.

In block S202, the travelling data is processed using an automatic driving algorithm to be checked to generate a prediction result.

It is to be noted that, the implementation processes of the above blocks S201 and S202 can refer to the above descriptions of the blocks S101 and S102 in the above embodiments, which will not be repeated herein.

In block S203, a reference result corresponding to the travelling data is obtained.

The reference result is a reliable result used to check the prediction result generated by the automatic driving algorithm to be checked. The reference result may be determined based on a preset rules, based on an operation of a driver of a current vehicle, or based on real travelling data, which is not limited herein.

In detail, methods for obtaining the reference result may be different in different scenarios.

For example, in an automatic driving scenario, when the automatic driving algorithm is checked, the reference result may be determined based on the operation result of the driver of the vehicle.

That is, during the travelling process of the vehicle, the operation of the driver can be collected in real time and the reference result can be determined based on the operation of the driver.

As an example, when the prediction result generated by the automatic driving algorithm to be checked is “the vehicle needs to brake after 5 seconds”, the reference result can be determined based on the operation of the driver. That is, it is determined whether the vehicle needs to brake, or when the vehicle needs to brake.

As another example, for checking the automatic driving algorithm to be checked, a reference algorithm associated with the automatic driving algorithm to be checked may be obtained, and the travelling data is processed by using the reference algorithm to determine the reference result.

It is understandable that the reference algorithm used to check the automatic driving algorithm to be checked is the autonomous driving algorithm that has a known reliability and accuracy, can be used to actually control the vehicle, and has the same function as the automatic driving algorithm to be checked.

In an example, the reference result can be determined based on the obtained real travelling data, i.e., the above block S203 may further include the following.

A check time corresponding to the prediction result is determined, and the reference result is determined based on the travelling data obtained at the check time.

In detail, when the prediction result generated by the automatic driving algorithm to be checked is a future event, the real travelling data at a time of the future event corresponding to the prediction result (i.e., the check time) can be obtained based on the check time. Therefore, the reference result is determined based on the real travelling data.

A case where the reference result is determined based on the obtained real travelling data will be described by taking pedestrians walking through in front of the vehicle as an example below.

Based on the travelling data obtained at the time to during the travelling process of the vehicle, it is determined that there is a pedestrian walking through in front of the vehicle currently. A corresponding processing model to be checked (such as a pedestrian walking through processing model) can be called to process the travelling data obtained at the time to. If the obtained prediction result is that the pedestrian will walk to a location (x, y, z) in front of the vehicle after t₁ seconds, the travelling data can be obtained continuously to determine the position (x′, y′, z′) of the pedestrian at the time (t₀+t₁) based on the obtained travelling data. The position (x′, y′, z′) is the reference result.

In block S204, target data to be collected is determined based on the automatic driving algorithm to be checked in a case where the difference between the prediction result and the reference result is greater than a threshold.

The target data can be determined based on the automatic driving algorithm to be checked. The target data includes any relevant data required for improving the automatic driving algorithm to be checked. For example, the target data can be the travelling data processed by the automatic driving algorithm to be checked, the prediction result, and the corresponding reference result.

In detail, when the prediction result is the same as the reference result, it can be determined that the accuracy and reliability of the automatic driving algorithm to be checked are both high. Correspondingly, when the prediction result is different from the reference result, it can be determined that the accuracy and reliability of automatic driving algorithm to be checked need to be further improved.

In embodiments of the disclosure, it can be determined whether to further improve the automatic driving algorithm based on difference between the prediction result and the reference result.

The threshold can be determined based on the scene and/or the type corresponding to the automatic driving algorithm to be checked.

The scene corresponding to the automatic driving algorithm to be checked may be a highway, a parking lot, an urban main road, or an intersection. The type corresponding to the automatic driving algorithm to be checked may be an anti-collision algorithm or a temperature control algorithm. Since different types or different scenarios have different requirements on the automatic driving algorithm, in the disclosure, the threshold can be determined based on the scene, the type, or both the scene and the type corresponding to the automatic driving algorithm to be checked.

For example, on the highway, the speed of the vehicle is fast, and the requirements on the automatic driving algorithm are correspondingly high. That is, the threshold can be a small value, such that when there is a small difference between the prediction result and the reference result, the autonomous driving algorithm needs to be further improved.

In the parking lot, the speed of the vehicle is slow, a probability that an accident affecting the personal safety occurs is usually low and the requirements on the automatic driving algorithm are correspondingly low. That is, the threshold can be a large value, such that when there is a large difference between the prediction result and the reference result, the autonomous driving algorithm needs to be further improved.

In block S205, the target data is sent to a server.

In detail, when the difference between the reference result and the prediction result is greater than the threshold, it can be determined that the reliability of the automatic driving algorithm to be checked is low, and the automatic driving algorithm to be checked needs to be further improved. The target data can be sent to the server, such that the server can modify and improve the automatic driving algorithm to be checked based on the target data.

The “brake” scenario will be taken as an example below to further describe the checking process of the automatic driving algorithm according to the disclosure.

During the travelling process of the vehicle, the travelling data of the vehicle that “brakes” is obtained at the time t₂, such as an angle of a brake pedal and a slope of the road. Based on the automatic driving model corresponding to the brake, the brake travelling data is processed to obtain the prediction result. For example, the prediction result is that the vehicle will stop within t₃ seconds. After that, the travelling data of the vehicle is continuously obtained. When it is determined that the vehicle stops exactly at that time based on the travelling data obtained at the time (t₂+t₃), it indicates that the automatic driving model corresponding to the “brake” is highly reliable. When it is determined that the vehicle is still travelling at that time based on the travelling data obtained at the time (t₂+t₃) and the vehicle stops after t₄ seconds, it can be determined whether there is a need to collect the target data and send the target data to the server to enable the server to modify and improve the automatic driving model based on whether the value of ta is greater than the threshold corresponding to the scene or not.

In some embodiments of the disclosure, the travelling data is obtained during the travelling process of the vehicle. The travelling data is processed using the automatic driving algorithm to be checked to generate the prediction result. The reference result corresponding to the travelling data is obtained. The target data to be collected is determined based on the automatic driving algorithm to be checked in the case that the difference between the prediction result and the reference result is greater than the threshold, and the target data is sent to the server. Through the above processing, not only the automatic driving algorithm to be checked can be checked in the real environment, but also the problem data under scenarios with insufficient tackling ability can be remedied purposefully based on the scene and/or the type corresponding to the automatic driving algorithm to be checked, which facilitates purposeful checking and improvement. In addition, sending the target data to the server provides data resources for research and development, which can provide good and comprehensive data support for algorithm evaluation, iteration, and expansion.

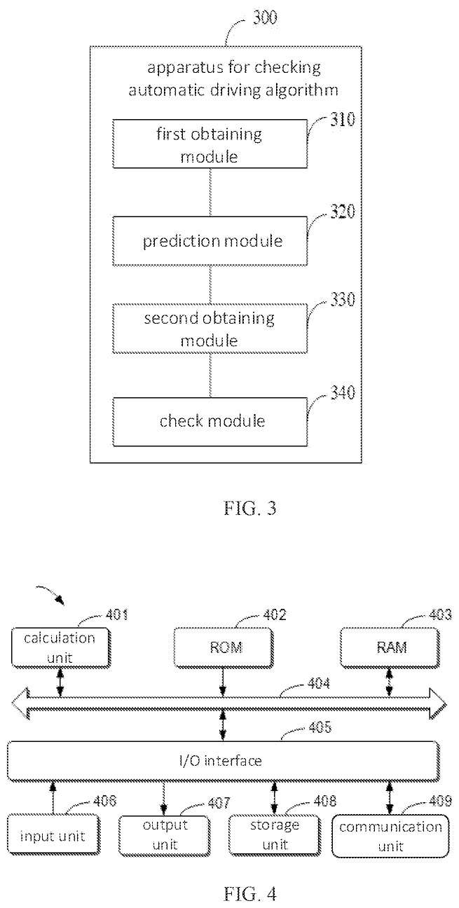

In order to implement the above embodiments, an apparatus for checking an automatic driving algorithm is also provided according to embodiments of the disclosure. FIG. 3 is a schematic diagram illustrating an apparatus for checking an automatic driving algorithm according to some embodiments of the disclosure.

As illustrated in FIG. 3, the apparatus 300 for checking an automatic driving algorithm includes a first obtaining module 310, a prediction module 320, a second obtaining module 330, and a checking module 340.

The first obtaining module 310 is configured to obtain travelling data during a travelling process of a vehicle. The travelling data includes an environmental parameter and/or a state parameter of the vehicle.

The prediction module 320 is configured to process the travelling data using an automatic driving algorithm to be checked to generate a prediction result.

The second obtaining module 330 configured to obtain a reference result corresponding to the travelling data.

The checking module 340 is configured to determine a reliability of the automatic driving algorithm to be checked based on a difference between the prediction result and the reference result.

In some embodiments of the disclosure, the above prediction module 320 is further configured to determine the automatic driving algorithm to be checked currently based on the travelling data.

In some embodiments of the disclosure, the above second obtaining module 330 is further configured to determine the reference result based on an operation result of a driver of the vehicle.

In some embodiments of the disclosure, the above second obtaining module 330 is further configured to obtain a reference algorithm associated with the automatic driving algorithm to be checked; and process the travelling data using the reference algorithm to determine the reference result.

In some embodiments of the disclosure, the above second obtaining module 330 is further configured to determine a check time corresponding to the prediction result, and determine the reference result based on the travelling data obtained at the check time.

In some embodiments of the disclosure, the apparatus further includes a data collection module. The data collection module is configured to determine target data to be collected based on the automatic driving algorithm to be checked in a case where a difference between the prediction result and the reference result is greater than a threshold. The data collection module is further configured to transmit the target data to a server.

In some embodiments of the disclosure, the apparatus further includes a determining module. The determining module is configured to determine the threshold based on a scene and/or a type corresponding to the automatic driving algorithm to be checked.

With the apparatus for checking an automatic driving algorithm according to embodiments of the disclosure, the travelling data during the travelling process of the vehicle is obtained. The travelling data is processed using an automatic driving algorithm to be checked to generate the prediction result. The reliability of the automatic driving algorithm to be checked is determined based on the difference between the prediction result and the corresponding reference result. Therefore, the reliability of the automatic driving algorithm is checked based on the real travelling data obtained during the real travelling process of the vehicle, which not only reduces the check cost, but also ensures the truth and reliability of the check result.

According to some embodiments of the disclosure, an electronic device, a readable-storage medium and a computer program product are also provided.

As illustrated in FIG. 4, FIG. 4 is a block diagram illustrating an electronic device for implementing a method for checking an automatic driving algorithm according to some embodiments of the disclosure. Electronic devices are intended to represent various forms of digital computers, such as laptop computers, desktop computers, work tables, personal digital assistants, servers, blade servers, mainframe computers, and other suitable computers. Electronic devices can also represent various forms of mobile apparatus, such as personal digital processors, cellular phones, smart phones, wearable devices, and other similar computing apparatus. The components illustrated herein, their connections and relationships, and their functions are merely examples, and are not intended to limit the implementation of the disclosure described and/or required herein.

As illustrated in FIG. 4, the device 400 includes a calculation unit 401, which can execute various appropriate actions and processing according to the computer program stored in a read only memory (ROM) 402 or the computer program loaded in a random access memory (RAM) 403 from the storage unit 408 so as to implement the method for checking an automatic driving algorithm provided by each embodiment. In the RAM 403, various programs and data required for the operation of the storage device 400 are also stored. The calculation unit 401, the ROM 402, and the RAM 403 are connected to each other through a bus 404. An input/output (I/O) interface 405 is also connected to the bus 404.

A plurality of components in the device 400 are connected to the I/O interface 405, including: an input unit 406, such as a keyboard, a mouse, and the like, an output unit 407, such as various types of displays, speakers, and the like; and a storage unit 408, such as a magnetic disk, an optical disk, and the like; and a communication unit 409, such as a network card, a modem, a wireless communication transceiver, and the like. The communication unit 409 allows the device 400 to exchange information/data with other devices through a computer network such as the Internet and/or various telecommunication networks.

The computation unit 401 may be various general-purpose and/or special-purpose processing components with processing and computing capabilities. Some examples of the computation unit 401 include but are not limited to central processing unit (CPU), graphics processing unit (GPU), various dedicated artificial intelligence (AI) computing chips, various computing units running machine learning model algorithms, digital signal processor (DSP), and any appropriate processor, controller, micro-controller, and the like. The calculation unit 401 executes each method and processing described above, such as the method for checking an automatic driving algorithm. For example, in some embodiments, the method for checking an automatic driving algorithm can be implemented as a computer software program, which is tangibly included in a machine-readable medium, such as the storage unit 408. In some embodiments, part or all of the computer program may be loaded and/or installed on the device 400 via the ROM 402 and/or the communication unit 409. When the computer program is loaded into the RAM 403 and executed by the calculation unit 401, one or a plurality of blocks of the method for checking an automatic driving algorithm described above can be executed. Alternatively, in other embodiments, the calculation unit 401 may be configured to implement a method for checking an automatic driving algorithm by any other suitable means (for example, by means of firmware).

Various implementations of the systems and technologies described herein can be implemented in digital electronic circuit systems, integrated circuit systems, field programmable gate arrays (FPGA), application specific integrated circuits (ASIC), application-specific standard products (ASSP), systems on chip (SOC), complex programmable logic device (CPLD), computer hardware, firmware, software, and/or their combination thereof. These various embodiments may be implemented in one or more computer programs, in which the one or more computer programs may be executed and/or interpreted on a programmable system including at least one programmable processor, in which the programmable processor may be a dedicated or general purpose programmable processor that can receive data and instructions from the storage system, at least one input apparatus, and at least one output apparatus, and transmit the data and instructions to the storage system, at least one input apparatus, and at least one output apparatus.

A computer program product is also provided in the embodiments of the present disclosure. The computer program product includes a computer program. When the computer program is executed by a processor, the method for checking an automatic driving algorithm described in any one of the embodiments can be implemented.

The program code used to implement the method of the present disclosure can be written in any combination of one or a plurality of programming languages. These program codes can be provided to processors or controllers of general-purpose computers, special-purpose computers, or other programmable data processing apparatus, so that when the program codes are executed by a processor or a controller, functions/operations specified in flowcharts and/or block diagrams are implemented. The program codes can be entirely executed on a machine, partly executed on a machine, partly executed on a machine as an independent software package and partly executed on a remote machine or entirely executed on a remote machine or a server.

In the context of the present disclosure, a machine-readable medium may be a tangible medium, which may include or store programs for use by instruction execution systems, apparatus, or devices, or for use by the combination of instruction execution systems, apparatus, or devices. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with the user, the systems and technologies described herein can be implemented on a computer and the computer includes a display apparatus for displaying information to the user (for example, a CRT (cathode ray tube) or an LCD (liquid crystal display) monitor)); and a keyboard and a pointing apparatus (for example, a mouse or a trackball) through which the user can provide input to the computer. Other types of apparatus can also be used to provide interaction with the user; for example, the feedback provided to the user can be any form of sensory feedback (for example, visual feedback, auditory feedback, or tactile feedback); and can be in any form (including acoustic input, voice input, or tactile input) to receive input from the user.

The systems and technologies described herein can be implemented in a computing system that includes back-end components (for example, as a data server), or a computing system that includes middleware components (for example, an application server), or a computing system that includes front-end components (for example, a user computer with a graphical user interface or web browser through which the user can interact with the implementation of the systems and technologies described herein), or a computing system that includes any combination of the back-end components, middleware components, or front-end components. The components of the system can be connected to each other through any form or medium of digital data communication (for example, a communication network). Examples of communication networks include local area networks (LAN), wide area networks (WAN), and the Internet.

The computer system may include a client and a server. The client and server are generally far away from each other and usually interact through a communication network. The relationship between the client and the server is generated by computer programs that run on the corresponding computer and have a client-server relationship with each other.

The electronic device, the readable storage medium, and the computer program product according to embodiments of the disclosure have the following beneficial effects.

The travelling data during the travelling process of the vehicle is obtained. The travelling data is processed using an automatic driving algorithm to be checked to generate the prediction result. The reliability of the automatic driving algorithm to be checked is determined based on the difference between the prediction result and the corresponding reference result. Therefore, the reliability of the automatic driving algorithm is checked based on the real travelling data obtained during the real travelling process of the vehicle, which not only reduces the check cost, but also ensures the truth and reliability of the check result.

It is to be understood that the various forms of processes illustrated above can be used to reorder, add or delete blocks. For example, the blocks described in the present disclosure can be executed in parallel, sequentially, or in a different order, as long as the desired result of the technical solution disclosed in the present disclosure can be achieved, this is not limited herein.

The above specific implementations do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of this disclosure.

What is claimed is:

1. A method for checking an automatic driving algorithm, comprising:
obtaining travelling data during a travelling process of a vehicle, wherein the travelling data comprises an environmental parameter of the vehicle, a state parameter of the vehicle, or both the environmental parameter and the state parameter;
processing the travelling data using an automatic driving algorithm to be checked to generate a prediction result;
obtaining a reference result corresponding to the travelling data; and
determining a reliability of the automatic driving algorithm to be checked based on a difference between the prediction result and the reference result.

2. The method of claim 1, further comprising:
determining the automatic driving algorithm to be checked currently based on the travelling data.

3. The method of claim 1, wherein obtaining the reference result corresponding to the travelling data comprises:
determining the reference result based on an operation result of a driver of the vehicle.

4. The method of claim 1, wherein obtaining the reference result corresponding to the travelling data comprises;
obtaining a reference algorithm associated with the automatic driving algorithm to be checked, and
processing the travelling data using the reference algorithm to determine the reference result.

5. The method of claim 1, wherein obtaining the reference result corresponding to the travelling data comprises:
determining a check time corresponding to the prediction result; and
determining the reference result based on the travelling data obtained at the check time.

6. The method of claim 1, further comprising:
determining target data to be collected based on the automatic driving algorithm to be checked in a case where the difference between the prediction result and the reference result is greater than a threshold; and
transmitting the target data to a server.

7. The method of claim 6, further comprising:
determining the threshold based on a scene, a type, or both the scene and the type corresponding to the automatic driving algorithm to be checked.

8. An electronic device, comprising:
at least a processor; and
a memory, communicatively coupled to at least one processor:
wherein the memory stores instructions executable by at least one processor, wherein when the instructions are executed by the at least one processor, the at least one processor is configured to:
obtain travelling data during a travelling process of a vehicle, wherein the travelling data comprises an environmental parameter of the vehicle, a state parameter of the vehicle, or both the environmental parameter and the state parameter;
process the travelling data using an automatic driving algorithm to be checked to generate a prediction result;
obtain a reference result corresponding to the travelling data; and
determine a reliability of the automatic driving algorithm to be checked based on a difference between the prediction result and the reference result.

9. The electronic device of claim 8, wherein the processor is further configured to:
determine the automatic driving algorithm to be checked currently based on the travelling data.

10. The electronic device of claim 8, wherein the processor is further configured to:
determine the reference result based on an operation result of a driver of the vehicle.

11. The electronic device of claim 8, wherein the processor is further configured to:
obtain a reference algorithm associated with the automatic driving algorithm to be checked; and
process the travelling data using the reference algorithm to determine the reference result.

12. The electronic device of claim 8, wherein the processor is further configured to:
determine a check time corresponding to the prediction result; and
determine the reference result based on the travelling data obtained at the check time.

13. The electronic device of claim 8, wherein the processor is further configured to:
determine target data to be collected based on the automatic driving algorithm to be checked in a case where the difference between the prediction result and the reference result is greater than a threshold; and
transmit the target data to a server.

14. The electronic device of claim 13, wherein the processor is further configured to:
determine the threshold based on a scene, a type, or both the scene and the type corresponding to the automatic driving algorithm to be checked.

15. A non-transitory computer-readable storage medium, having computer instructions stored thereon, wherein the computer instructions are configured to cause a computer to execute a method for checking an automatic driving algorithm, the method comprising:
obtaining travelling data during a travelling process of a vehicle, wherein the travelling data comprises an environmental parameter of the vehicle, a state parameter of the vehicle, or both the environmental parameter and the state parameter;
processing the travelling data using an automatic driving algorithm to be checked to generate a prediction result;
obtaining a reference result corresponding to the travelling data; and
determining a reliability of the automatic driving algorithm to be checked based on a difference between the prediction result and the reference result.

16. The non-transitory computer-readable storage medium of claim 15, wherein the method further comprises:
determining the automatic driving algorithm to be checked currently based on the travelling data.

17. The non-transitory computer-readable storage medium of claim 15, wherein obtaining the reference result corresponding to the travelling data comprises:
determining the reference result based on an operation result of a driver of the vehicle.

18. The non-transitory computer-readable storage medium of claim 15, wherein obtaining the reference result corresponding to the travelling data comprises:
obtaining a reference algorithm associated with the automatic driving algorithm to be checked; and
processing the travelling data using the reference algorithm to determine the reference result.

19. The non-transitory computer-readable storage medium of claim 15, wherein obtaining the reference result corresponding to the travelling data comprises:
determining a check time corresponding to the prediction result; and
determining the reference result based on the travelling data obtained at the check time.

20. The non-transitory computer-readable storage medium of claim 15, wherein the method further comprises:
determining target data to be collected based on the automatic driving algorithm to be checked in a case where the difference between the prediction result and the reference result is greater than a threshold; and
transmitting the target data to a server.
